(19) United States
(12) Patent Application Publication
(10) Pub. No.: US 2005/0044769 A1
(43) Pub. Date: Mar. 3, 2005

(54) Universal adjustable equipment mount

(76) Inventors: Hans Ruiz, Gardena, CA (US); Glenn Smith, Westchester, CA (US)

Correspondence Address: Windline, INC., 234 W. 146th Street, Gardena, CA, 90248, US

(21) Appl. No.: 10/647,684

(22) Filed: Aug. 25, 2003

(51) Int. Cl. A01K 97/10

(52) U.S. Cl. 43/21.2

(57) ABSTRACT

An adjustable mount used for mounting equipment of the type used aboard marine or other water-borne craft. The mount itself is mounted to the ship, and has as its main components a hollow, cylindrical C-extrusion, adjustable slide brackets, and mounting brackets. The C-shaped bases of the slide brackets are housed within the hollow center of the C extrusion. Equipment is mounted to the slide brackets, which can be adjusted either up or down on their own axis or laterally across the length of the C extrusion. The mounting brackets secure the entire assembly to the boat structure and serve as an adjustment mechanism for the C-extrusion.

### BACKGROUND-FIELD OF INVENTION

This invention relates to equipment mounts used on marine vessels and other water-borne craft. Such equipment mounts are commonly used to mount lights, fishing rods, reels of fishing cable, and other marine equipment.

### BACKGROUND-DESCRIPTION OF PRIOR ART

In a water-borne or marine environment, pleasure craft used for recreational purposes have a highly limited amount of space available on their deck areas. When these craft are not large to begin with, the amount of deck space that is available is even more limited. This problem is made even worse when recreational items such as fishing rods, or necessary items, such as lights and boarding ladders, are left on the deck to consume even more of what little space is available. In addition, on typical recreational boats, there is usually not just one fishing rod or one light, but several. This hijacking of space is not the only problem presented by these items left on the deck. They are also dangerous because people could trip over them. Or, during rough seas, they could roll into someone and cause injury. It is therefore imperative in this type of situation that a means is found to mount these items off the deck in a safe, efficient, and inconspicuous manner.

Most of the mounting devices currently available have been developed solely for mounting fishing rods. In addition, most of these are for mounting fishing rods while they, the rods, are in use. Most of them do not have any provision for mounting the rods after they are no longer being used. When they are designed for mounting rods after the rods have been used, they usually exist as single units and therefore put the installer through the hassle of having to mount several one-at-a-time. Most of the others in existence are for only storing the rods after they have been taken off the boat. In addition, they do not address the issue of mounting other items found on the boat, such as lights, dive ladders, and reels of fishing line.

Because of this, a need has arisen for some type of universal mounting device that can not only mount fishing rods but other items as well. It should also be easy to mount and mounted in a place where it does not take up much space. Another necessary feature of this type of mount would be the ability to mount several items on one mount instead of having to install a separate mount for each item that needs to be mounted. Several mounts have been developed that only partially or barely address these needs. One such mount, or holder, already developed is one used to mount fishing rods in U.S. Pat. No. 4,793,086 to Cup, Dec. 27, 1988. It is meant for mounting fishing rods and is meant to be attached to the transom, or railing of a boat. However, it is only for a fishing rod and is only meant to mount the fishing rod while it is being used. It holds only two rods, and does not allow for vertical adjustment. Another holder, or mount, is presented in U.S. Pat. No. 4157803 to Mack, Jun. 12, 1979. This one has the advantage of housing several rod holders along its body, yet it has drawbacks in that each rod holder cannot be adjusted either on its own axis or along the length of the body to which it is attached. Ability to adjust the rod holders gives the operator the ability to set the desired angle of the rod while fishing and the ability to set the rod holders back while the rods are mounted and not being used. In addition, this design only mounts fishing rod holders and no other equipment. Another example pertaining to this class of devices can be found in U.S. Pat. No. 6,289,627 to Gibbs et al, Sep. 18, 2001. This device, like the one attributed to Mack mentioned previously, has the advantage in that it houses a plurality of rod holders along its main body, which consists of a pair of folding support arms. Like the one attributed to Mack, however, its design does not allow for the individual rod holders to be adjusted, either along their own axis or along the length of the folding support arms they are attached to. Also like the one attributed to Mack, it only provides for the mounting of fishing rods.

Some important objects of the invention presented here are to provide a versatile, rugged, compact, and adjustable mount that can be used to mount not only fishing rods but also a variety of marine accessories.

### OBJECTS AND ADVANTAGES

The majority of the fishing rod or marine accessory holders, or marine mounting devices in existence are inadequate in that they are either too cumbersome or non-adjustable, or are limited to mounting fishing rods. In addition, in many instances they have to be installed in locations where they are either too conspicuous or they get in the way of crew movement. Some of their designs are bulky, taking up needed space and adding weight to vessels that cannot afford to be weighted down.

On some marine pleasure craft, there may be more than one, if not several, people aboard who have brought their fishing rods along in order to fish with. This large number of rods, along with other equipment, simply cannot be left on the deck where it could pose a tripping hazard. They need to be brought off the deck to eliminate this potential danger.

As well as being simple in design, the universal adjustable equipment mount presented here provides a compact, strong, durable, adjustable, and convenient way to mount not only fishing rods but other types of marine gear as well. Accordingly, several objects and advantages of this invention are:
1. This equipment mount is simple in design. It consists of a long, c-shaped cylindrical C-extrusion tube with locking solid round bar end-pieces at both ends. The end-pieces are affixed within the C-extrusion with screws. Along the length of the entire C-extrusion runs an elongated cavity cut into its surface, hence giving it the C-shape when looked at from the side. The C-shaped cavity has horizontal ridges from one end of the C-extrusion to the other end. Inside this cavity along the length of the C-extrusion are inserted several t-shaped slide brackets made of extruded aluminum, getting their name from the fact that they can slide along the length of the C-extrusion on their circular C-shaped base inside this cavity. The slide brackets have a ridge in the base which holds the desired angle in place by wedging between the ridges in the C-extrusion. The slide brackets are secured by tightening a set-screw through the C-shaped base of each slide bracket. The opposite end of the slide brackets has a footpad with screw holes. It is to these slide bracket footpads that fishing rod holders, lights, and other equipment can be attached. There are end-pieces made of short pieces of solid round aluminum bar at each end of the C-extrusion. Attached to and extending outward from each locking end-piece at the ends of the C-extrusion are the mounting brackets. The mounting bracket is a rectangular piece of material with one end bent perpendicular and at a slight angle, and the other end, with rounded corners, attaches to the end piece. The mounting brackets are secured to the locking end-piece with socket head flat screws. These mounting brackets are used to attach the universal mount to whatever surface the user desires by affixing the mounting bracket to the surface using the three pre-drilled holes in the mounting bracket.
2. The universal mount is compact and does not take up much room. It is comprised of the C-extrusion, the two mounting brackets, the locking end-piece, some screws, the socket head flat screws, and the slide brackets. They are all arranged linearly along the C-extrusion, and the entire assembly is usually attached to the hardtop, or roof, of the boat, where it is out of the way of deck traffic.
3. The universal mount is strong and durable. The C-extrusion and the other components are made of solid, extruded aluminum, and are capable of withstanding many pounds per square inch of pressure and force. The mount is durable because its hard aluminum construction makes it resistant to rust and corrosion.
4. The universal mount is adjustable. Each angular t-shaped extrusion slide bracket can rotate up or down on its own axis, and can slide anywhere along the length of the C-mount. This is made possible by a single ridge on the slide bracket base which fits between the ridges in the cavity of the C-extrusion and acts as a wedge to guide and secure the desired angle of the slide bracket. A setscrew in the base of the slide bracket expands the base and secures the desired angle. This is beneficial when one needs to adjust lights that have been mounted or secured at a desired angle by tightening a set screw in the section of the mounting bracket which mates with the end-piece at each end of the C-extrusion.
5. The mounting system is convenient. It is convenient because it is easy to use and easy to mount. Using it involves simply attaching the mounting brackets to the boat, then adjusting the c-extrusion to whatever position is desired and then tightening the socket-head flat screw through the mounting bracket and into the end piece. Mounting the Universal Adjustable Equipment mount to the boat involves a few screws through the mounting brackets. In addition, it does not take up much room, since it is primarily intended to be mounted on the hardtop or roof, of most marine pleasure craft.
6. The Universal Equipment Mount is universal. Although the mounting system comes with a rod holder mounted to each slide-bracket for holding fishing poles, these cylinders can be replaced with other holding devices to hold lights, tools, flags, etc. An entire product accessory repertoire can be introduced to enhance the versatility of the Equipment Mount. The slide bracket is made to easily remove and replace the supplied rod holder with accessories by loosening two screws in the face plate of the slide bracket.

### BRIEF DESCRIPTION OF DRAWINGS

FIG. 1 is a side view of the universal mount as viewed from one end of the equipment assembly.

FIG. 2 is a front-on view of the universal mount, showing two rod holders, two slide bracket face plates, the entire length of the C-extrusion, end pieces inside the C-extrusion, and mounting brackets attached to the end pieces.

FIG. 3 is a cut-away side view showing a side view of the C-extrusion and a view of the C-shaped base of the slide bracket and its single ridge in the open space of the C-extrusion. Also shown is the rod holder removed from the face plate of the slide bracket.

FIG. 4 is a side cut-away view of the universal mount depicting the slide bracket before the angle is adjusted as shown in FIG. 5.

FIG. 5 is a side cut-away view of the universal mount showing the movement of the slide bracket as the angle of the rod holder is adjusted.

FIG. 6 is a front view of the universal mount indicating a rod holder which will be demonstrating the sideways movement of the slide bracket as shown in FIG. 7.

FIG. 7 is a front view showing the movement of the rod holder as the slide bracket is moved along the groove in the C-extrusion.

FIG. 8 is a close up view of the ridges in the C-extrusion, the single ridge in the base of the slide bracket, the setscrew in the base of the slide bracket and the screw holes in the face plate of the slide bracket used for mounting accessories.

FIG. 9 is a close up view of the placement of the end-piece within the cavity of the C-extrusion and the screw which shows the means of securing the end piece in place.

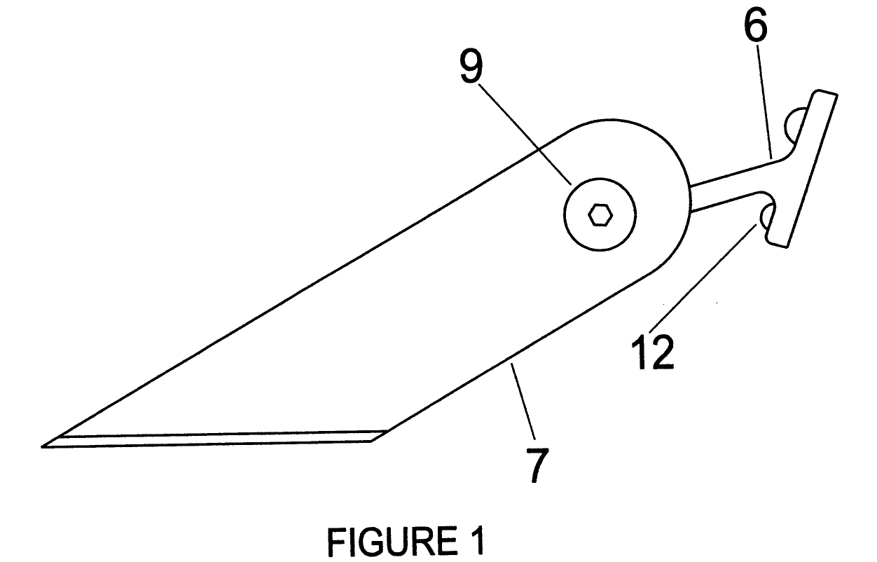

### Reference numerals for FIGS. 1-7.

FIG. 1

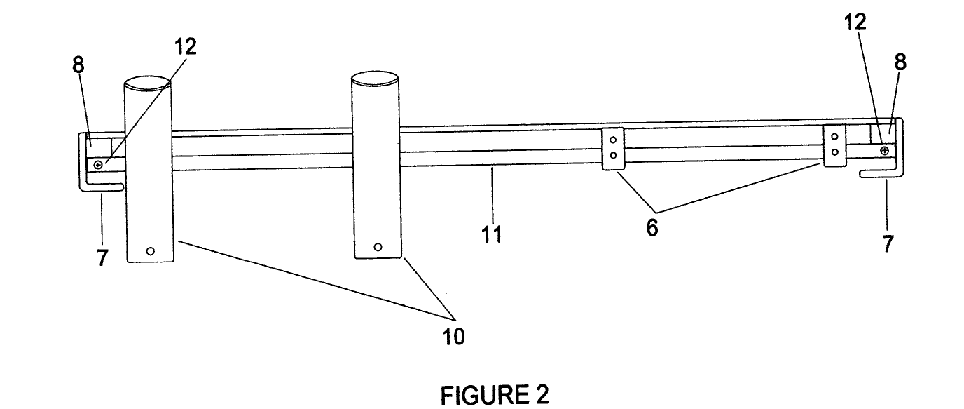

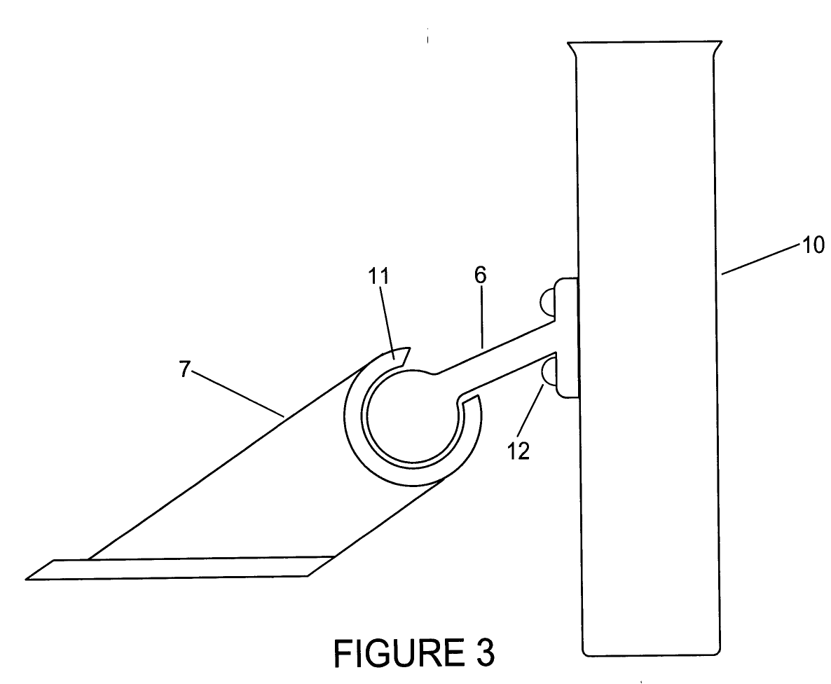

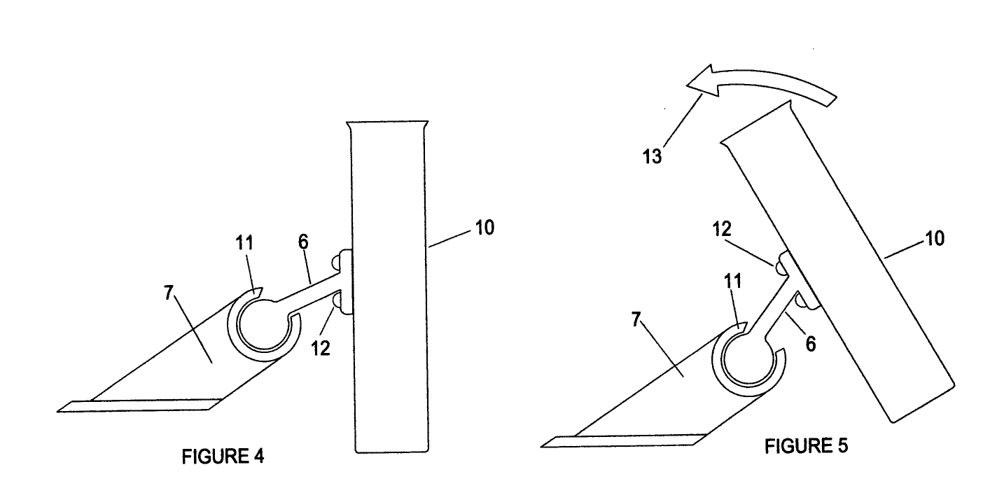

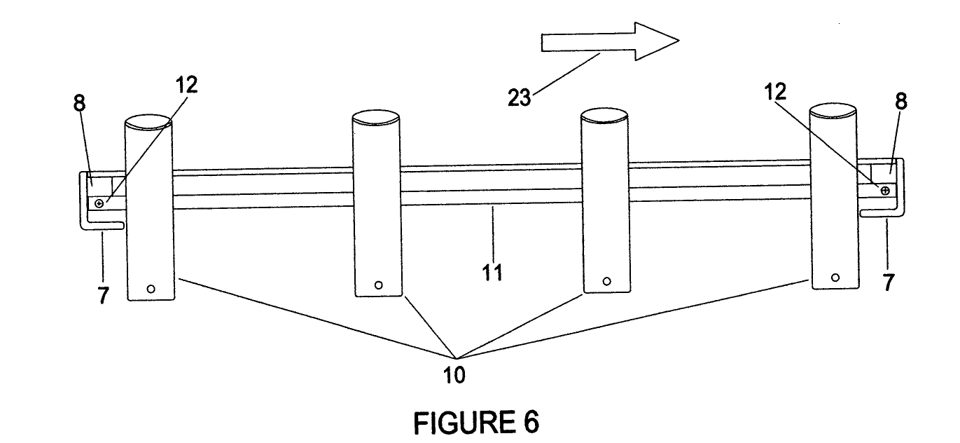

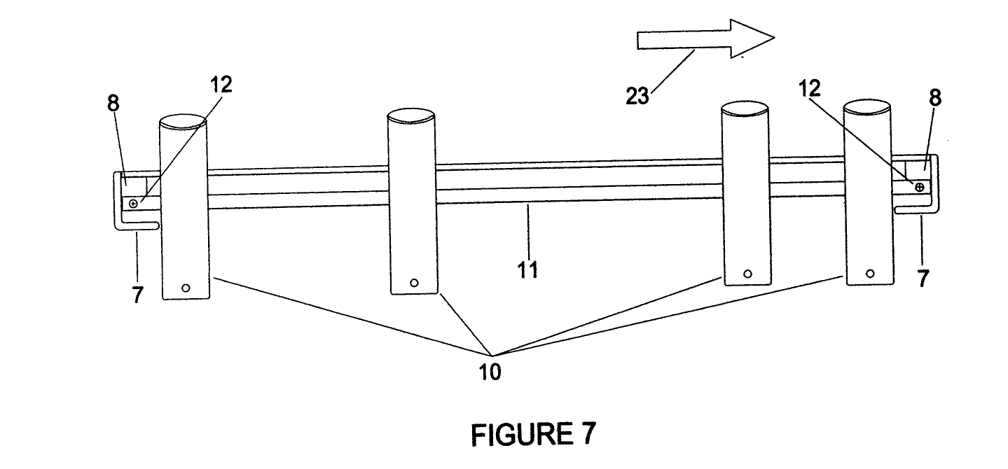

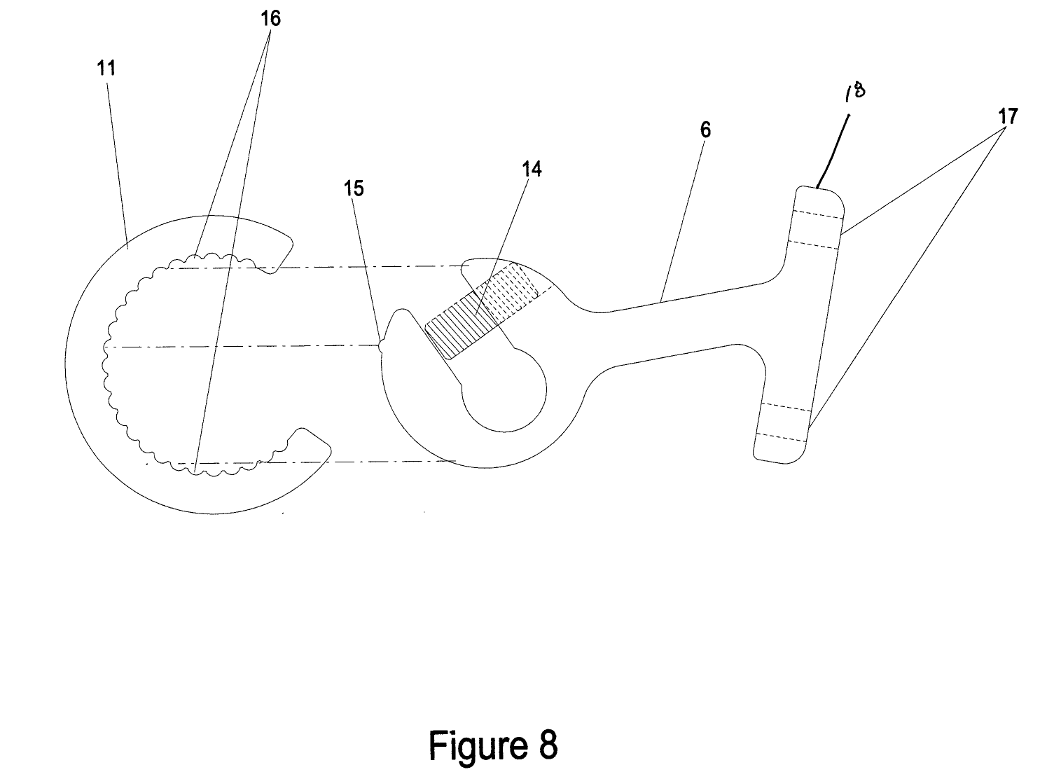

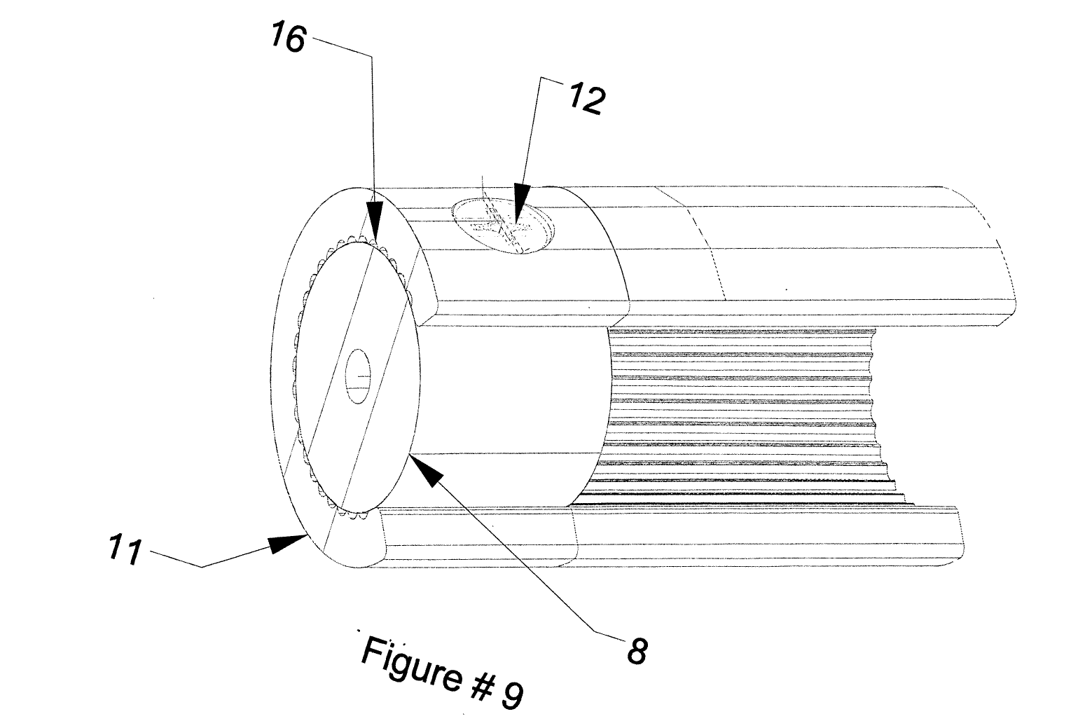

7.—slide bracket
8.—mounting bracket
9.—socket head flat screw
12.—screws
   FIG. 2
6.—slide brackets
7.—mounting brackets
9.—locking end-piece
10.—rod holders
11.—C-extrusion
12.—screws
   FIG. 3
6.—slide bracket
7.—mounting bracket
10.—rod holder detached from the face plate of the slide bracket
11.—C-extrusion
12.—screws
14.—setscrew
15.—single ridge on the slide bracket base
16.—ridges in the interior of the C-extrusion
   FIG. 4
6.—slide bracket
7.—mounting bracket
10.—rod holder
11.—C-extrusion
12.—screws
   FIG. 5
6.—slide bracket
7.—mounting bracket
10.—rod holder
11.—C-extrusion
12.—screws
13.—arrow showing direction of movement or direction of force
   FIG. 6
7.—mounting bracket
8.—locking end-piece
10.—rod holders
11.—C-extrusion
12.—screws
23.—arrow showing direction of movement or force.
   FIG. 7
7.—mounting brackets
8.—locking end-piece
10.—rod holders
11.—C-extrusion
12.—screws
23.—arrow showing direction of movement or force
   FIG. 8
6.—slide bracket
11.—C-extrusion
14.—setscrew
15.—single ridge in the base of the slide bracket
16.—ridges in the cavity of the C-extrusion
17.—mounting holes in the face plate of the slide bracket
   FIG. 9
8.—end-piece
11.—C-extrusion
12.—screw
16.—ridges in the cavity of the C-extrusion

### SUMMARY OF THE INVENTION

A universal adjustable equipment mount for use as a general equipment mount aboard marine craft and comprised of a C-extrusion, slide brackets, mounting brackets, rod holders, locking end-pieces, socket-head flat screws, pan head screws, and setscrews. The rod holders are considered optional equipment, and can be detached and replaced with other accessory attachments. Several slide brackets are inserted into and occupy the open center that runs along the length of a C-extrusion which is cylindrical in shape. This gives the equipment mount its horizontal and vertical adjustment versatility. A pair of supplied mounting brackets mounts the C-extrusion to a selected surface, usually the hardtop of a vessel. The mounting brackets are anchored to the open ends of the C-extrusion by attaching to a pair of locking end-pieces made of solid round bar, which have been inserted into those open ends and fastened to the C-extrusion with screws. Socket-head flat screws attach the mounting brackets to the locking end-pieces. The slide brackets have the ability to slide sideways along the length of the open center of the C-extrusion, and can also be tilted up and down on their own axis. The exact position of the slide brackets is held in place by a ridge on the base of the slide bracket which is wedged between the ridges in the cavity of the C-extrusion. The slide bracket positioning is secured by tightening a setscrew through the C-shaped base of each slide bracket. The expansion of the base by the setscrew is part of the operating mechanism permitting multiple adjustment positions. On the opposite end of the slide brackets are holes through a face plate which screws are inserted which enable one to mount a variety of equipment, including lights and fishing rod holders.

### DETAILED DESCRIPTION AND OPERATION OF INVENTION—FIGS. 1-9

Referring in greater detail to the drawings:

FIG. 1 is a side view showing mounting bracket 7 attached by socket-head flat screw 9 to a locking end-piece, which is not shown in this drawing. Also shown is a slide bracket 6 and screw(s) 12.

FIG. 2 is a front view showing greater detail of the invention than a side view. It shows the mount, as it would look head-on if it were mounted on the hardtop, or roof, of a boat. It shows mounting brackets 7 attached to locking end-piece 8 which are attached to C-extrusion 11 by screw(s) 12. Also shown are rod holders 10 which are mounted on slide brackets 6.

FIG. 3 is a cutaway view from the side showing the slide bracket 6 mounted in the cavity of the C- extrusion 11. The slide bracket 6 is held in place by a single ridge 15 in its base and placed between the ridges of the C-extrusion (not shown), and secured by a setscrew 14 which is inside the C-shaped base of the slide bracket. Mounting bracket 7 is anchored to C-extrusion 11 by the locking end-piece, which is not shown in this picture. This view also shows rod holder 10 which is detached from the face plate of the slide bracket 6. Screws 12 attach the rod holder 10 and other accessories (not shown) to the slide bracket 6.

FIG. 4 is essentially the same view as FIG. 3. It is there, however, to give perspective to the movement shown in FIG. 5.

FIG. 5 shows how the slide brackets with their attachments can be adjusted up or down. Rod holder 10 attached to slide bracket 6 moves in the direction of arrow 13 as the height is adjusted. It can also be adjusted downward as well. Slide bracket 6 moves within C-extrusion 11 which is anchored to a surface by a mounting bracket 7. As before, rod holder 10 is attached to slide bracket 6 by screw(s) 12.

FIG. 6 is similar to FIG. 2, with the exception that it shows a full complement of rod holders. However, its main purpose is to help explain the movement shown in FIG. 7. In FIG. 6 the arrow 23 showing direction of movement and/or force, is placed above the rod holder that will demonstrate the movement along C-extrusion 11.

FIG. 7 shows the ability of the slide brackets with their attachments to move laterally along the C-extrusion. A force indicated by arrow 23 moves the rod holder 10 specifically, the rod holder beneath arrow 23 which is connected to a slide bracket as seen in FIGS. 3, 4, and 5. As this happens, the slide bracket along with rod holder 10 connected to it moves along open center of C-extrusion 11. In this way it is adjustable along the length of C-extrusion 11. The entire apparatus is mounted to a surface by mounting brackets 7, which are attached to locking end-piece 8. Locking end-piece 8 is attached to C-extrusion 11 by screws 12.

FIG. 8 is a close up view of the interaction between the slide bracket and the C-extrusion. The slide bracket 6 occupies the cavity of the C-extrusion 11 where the single ridge 15 on the base of the slide bracket 6 is wedged between the ridges 16 in the C-extrusion 11. A setscrew 14 expands or contracts the base of the slide bracket 6 to secure the slide bracket 6 within the C-extrusion 11. Also shown are the holes 17 used for affixing accessories to the face plate 18 of the slide bracket 6.

FIG. 9 is a close up of the end-piece 8 affixed in the cavity at one end of the C-extrusion 11 while resting on the ridges 16 along the interior of the C-extrusion 11. A screw 12 in the C-extrusion 11 secures the end-piece 8 in position.

### CONCLUSION, RAMIFICATIONS, AND SCOPE OF INVENTION

After reviewing the above information, the reader will be able to see that the universal adjustable equipment mount presented here provides a vast improvement over other mounting systems for boats that are currently available. It is simple in design and easy to manufacture. It is compact, and since it mounts to the hardtop, or roof, of a boat, it doesn't take up any room on the deck. In addition to these advantages, other advantages of the Universal Adjustable Equipment Mount are:
It is versatile in that it can mount a variety of equipment besides rod holders. Most mounts currently available only mount rod holders: this mount, however, not only mounts rod holders on the face plate of the slide bracket, but also other types of equipment such as lights, cable reels, and dive ladders.

It is adjustable. Most of the mounts that exist are not adjustable. This equipment mount is.

Its slide brackets, the components to which items such as lights and rod holders are mounted on, can be adjusted up and down; they can also be traversed along the length of the entire equipment mount. This enables the user to great versatility in adjusting lights, fishing rods, or other equipment that has been mounted on the Universal Equipment Mount.

It is unobtrusive. Since it is much longer than it is wide, the universal mount does not protrude out far. Also, since it is mounted on the roof of the boat, it is out of the way of most deck activity and does not take up valuable deck space.

While the above description contains many details and specifications, these should not be considered a limitation on the scope of this invention, but rather as a description of one preferred embodiment of this mechanism. Several other variations are possible. Adjustable mounts with different shapes could be made, or mounts utilizing differently shaped slide brackets or mounting brackets could be made. Other mounts could be made utilizing different materials, such as plastic, aluminum, hardened rubber, or polyurethane. This could be especially helpful if someone were looking for a mount that needed to be extremely light in weight.

Thus the scope of the invention should be determined by the following claims and their legal equivalents, rather than by the specifications and examples given.

1. An adjustable mount for securing marine equipment comprising:
a hollow c-shaped cylindrical extrusion of material (C-extrusion), having an empty interior, and; ridges along entire inside surface of said hollow c-shaped cylindrical extrusion of material,
a plurality of slide brackets comprised of angular t-shaped extrusions of material with circular C-shaped bases, and;
said circular C-shaped bases of said slide brackets occupying said empty interior of said hollow C-shaped ridged cylindrical extrusion of material, and;
each said slide bracket held in place by a single ridge on its base and secured by a setscrew through the C-shaped base, and:
there is a round locking end-piece of solid round bar in each end of said hollow c-shaped cylindrical extrusion of material, and;
means, including a plurality of screws, for fastening said end-piece to ends of said hollow c-shaped cylindrical extrusion of material, and;
a plurality of mounting brackets comprised of flat segments of material bending along a line into two planes perpendicular to each other resulting in an L-shape when viewed head on, and;
said mounting brackets extend from each said end-piece of solid round bar in each end of said hollow c-shaped cylindrical extrusion of material, and;
means, including a of flat screw, for fastening said mounting brackets to said end-pieces in the ends of said hollow C-extrusion of material.

2. The adjustable mount of claim 1, wherein said slide brackets slide through said ridged C-extrusion and slide through the entire length of said hollow c-shaped ridged cylindrical extrusion.

3. The adjustable mount of claim 1, wherein said slide brackets are made of extruded aluminum.

4. The adjustable mount of claim 1, wherein the base of the slide brackets have a ridge to guide the slide bracket along the length of the C-extrusion.

5. An adjustable mount for securing marine equipment comprising:
a hollow cylindrical tube having open ends, an open center all along its axis, and an open portion of surface all across its length with ridges from end to end,
a plurality of slide brackets comprised of pieces of extruded material with each having a semi-circular C-shaped base with a single ridge on the base, a portion extending from said semi-circular C-shaped base, and a segment crossing over at an angle to and connected to said portion extending from said semi-circular C-shaped base,
said semi-circular C-shaped bases of said slide brackets occupying said open center of said hollow cylindrical tube,
said portions extending from said semi-circular C-shaped bases of said slide brackets protruding from said open portion of surface of said hollow cylindrical tube,
a length of tubular material in each said open end of said hollow cylindrical tube,
a length of flat rectangular material having rounded corners at one end and bending at the other end into perpendicular planes extending from each said length of tubular material,
means, including a plurality of flat screws, for fastening said rounded ends of said lengths of the rectangular material to said end-piece of tubular material.

6. The adjustable mount of claim 5, wherein said slide brackets have the ability to slide through said open center of said hollow cylindrical C-extrusion with said single ridge of said slide bracket base between said ridges inside said C-extrusion.

7. The adjustable mount of claim 5, wherein said hollow cylindrical tube is made of extruded aluminum.

8. An adjustable mount for securing marine equipment comprising:
a cylindrical extrusion of material having open ends, a hollow, open body, and an elongated ridged cavity along the length of its surface giving said open ends a C shape,
a plurality of slide brackets with each said bracket comprising a single extruded piece of material having a semi-circular C-shaped base with a single ridge, an extending stem portion, and a portion running crosswise and at an angle across an end of said extending stem portion, said semi-circular C-shaped bases of said brackets occupying said hollow, open body of said cylindrical extrusion of material,
said extending stem portions of said slide brackets protruding from said elongated cavity along length of said cylindrical C-extrusion of material,
a cylindrical segment of material occupying each said open end of said cylindrical extrusion of material,
means, including a plurality of screws, for fastening said cylindrical segments of material to said open ends of said cylindrical extrusion of material,
a mounting bracket formed from a single extrusion extending from the end of each said cylindrical segment facing out of each said open end of said cylindrical extrusion of material, means, including a plurality of socket-head screws, for attaching each said mounting bracket to each end of each said cylindrical segment of material facing out of each said open end of said cylindrical extrusion of material,
said semi-circular C-shaped bases of said slide brackets having the ability to slide back and forth along the length of said hollow, open body of said cylindrical extrusion of material, and;
said semi-circular C-shaped bases of said slide brackets having ability to rotate up or down partially across the axis of said cylindrical extrusion of material.

9. The adjustable mount of claim 8, wherein said cylindrical end-piece segments of material are made of extruded aluminum.

10. An adjustable mount for securing marine equipment comprising:
a cylindrical extrusion with a hollow interior and open ends formed by a ridged cavity running along the length of its surface from end to end,
a cylindrical segment of material residing in each said open end of said cylindrical extrusion, means, including a plurality of screws, for afixing said cylindrical segments of material to said open c-shaped ends of said cylindrical extrusion,
a plurality of slanted L-shaped mounting brackets formed from single pieces of flat extruded material,
means, including a plurality of socket-head flat screws, for securing said L-shaped mounting brackets to ends of said cylindrical segments of material facing out of said open c-shaped ends of said cylindrical extrusion,
a plurality of brackets comprised of single extruded pieces of material having semi-circular C-shaped bases with a single ridge and T-shape extending appendages,
said semi-circular C-shaped bases of said slide brackets residing in said hollow interior of said cylindrical C-extrusion,
said T-shape extending appendages of said plurality of slide brackets protruding from said cavity running along said length of said surface of said cylindrical extrusion,
said semi-circular C-shaped bases of said slide brackets having sliding movement ability through said hollow interior of said cylindrical extrusion, and;
said semi-circular C-shaped bases of said brackets having partial rotational movement ability across the axis of said cylindrical extrusion.

11. An adjustable mount for securing marine equipment comprising:
a hollow cylindrical extrusion having a cavity along its surface ending in c-shaped ends, and;
said hollow cylindrical extrusion having a hollow ridged interior, and; a cylindrical length of material running parallel to said hollow cylindrical extrusion and residing in each said c-shaped end of said hollow cylindrical extrusion, and; means, including a plurality of screws, for fastening said cylindrical lengths of material to said c-shaped ends of said hollow cylindrical extrusion, and; a mounting bracket extending from each end of said cylindrical lengths of material facing out of said c-shaped ends of said hollow cylindrical extrusion, and; means, including a plurality of flat-head screws, for adhering said mounting brackets to said ends of said cylindrical lengths of material facing out of said c-shaped ends of said hollow cylindrical extrusion, and;
a plurality of brackets comprising a rectangular extrusion with each having one end with rounded corners, a stem-shaped middle portion, and the other end bent at an perpendicular angle to said stem-shaped middle portion, and;
said rounded end affixed to said solid round rod end within the end of said C-extrusion, and C-shaped bases of said slide brackets occupying said hollow interior of said hollow cylindrical extrusion, and;
said plurality of brackets having the ability to slide along said hollow interior of said hollow cylindrical extrusion along the said single ridge of the base and between said ridges of said C-extrusion, and;
said plurality of brackets having the ability to move up and down across a portion of the circumference of said hollow cylindrical extrusion defined by the distance between the edges of said cavity along the surface of said hollow cylindrical extrusion.

12. The said slide-bracket has foot pads opposite the base which come with a removable said rod holder to accommodate alternative holding devices which will be offered as accessories.

13. The said single ridge in the base of said slide bracket locates the slide bracket position.

14. The said slide bracket is secured by tightening a setscrew within the c-shape base of the slide bracket.

15. The function of the single ridge on the base of the slide bracket.

16. The function of the setscrew within the base of the slide bracket to expand or contract the base and prevent or allow movement of the slide bracket.

17. The face plate on the slide bracket to mount accessories on the slide bracket.

18. The holes in the face plate on the slide bracket to mount accessories.
